(19) United States
(12) Patent Application Publication
(10) Pub. No.: US 2014/0047386 A1
(43) Pub. Date: Feb. 13, 2014

(54) DIGITAL ASSET TAGGING

(71) Applicant: Digital Fridge Corporation, Greenwood Villiage, CO (US)

(72) Inventors: PETER AARON LYNCH, Highlands Ranch, CO (US); TODD MICHAEL PETERSEN, Castle Pines, CO (US); JOSEPH JEAN ROBERT DEGRASSE, Greenwood Village, CO (US); DOMINIQUE COLUSSI, Santo Domingo (DO); BRIAN MICHAEL REYMAN, Highlands Ranch, CO (US)

(73) Assignee: Digital Fridge Corporation, Greenwood Villiage, CO (US)

(21) Appl. No.: 13/966,116

(22) Filed: Aug. 13, 2013

Related U.S. Application Data
(60) Provisional application No. 61/682,583, filed on Aug. 13, 2012.

(51) Int. Cl. G06F 3/0482

(52) U.S. Cl. CPC G06F 3/0482
USPC 715/810

(57) ABSTRACT

Technologies including devices, computer readable media, and processes are provided for application of meta tagging data (tags) to digital assets such as digital photos, videos, audio files, text files, etc. Disclosed technologies generate tagging suggestions according to a number of different approaches. The different approaches for generating tagging suggestions may be selectable by the user, providing for fast and powerful association of relevant tags with digital assets.

### CROSS REFERENCE TO RELATED APPLICATIONS

Priority is claimed to U.S. Provisional Patent Application No. 61/682,583, filed on 13 Aug. 2012, entitled “DIGITAL ASSET TAGGING,” the disclosure of which is incorporated herein by reference in its entirety.

### BACKGROUND

The management of digital assets such as digital photos, videos, audio files, and text files such as by storing, securing, classifying, etc., is quickly becoming a critical need for consumers and businesses. With more users of portable devices such as smart phones, tablets, and other mobile devices, and with the increasing functionality and power of portable devices, and with the rise of the internet and social media, the ease of capturing and sharing digital assets is growing rapidly, resulting in an explosion in the volume of digital assets people manage.

As a result, there is an ongoing need in the industry for technologies allowing fast, simple, understandable, and powerful management of digital assets.

### SUMMARY

Technologies including methods, devices, and computer readable media applicable to digital asset tagging are disclosed. In some example methods for tagging a digital asset by a computing device, the computing device may display a tagging selection User Interface (UI) adapted to receive a tagging method selection from among a plurality of selectable tagging methods for applying tags to the digital asset. The plurality of selectable tagging methods may comprise, e.g., a “last” tagging method, a “recent” tagging method, a “batch” tagging method, a “location” tagging method, a “situational” tagging method, a “location-based batch” tagging method, a “situational batch” tagging method, a “recognition” tagging method, and/or a “social network data” tagging method, each of which are described in further detail herein. Upon receiving a tagging method selection, the computing device may display a corresponding digital asset tagging UI comprising a plurality of tagging suggestions. Users may modify and confirm one or more tags from among the tagging suggestions, and the computing device may associate confirmed tags with the digital asset and store the associated confirmed tags.

In addition to enabling tagging method selection, the computing device may provide a type tagging field for assisted manual entry of tags for the digital asset. The computing device may be adapted to display selectable auto-complete suggestions as a user types tags in the type tagging field, the auto-complete suggestions including, e.g., suggestions from a database of previously applied tags. The database may include tags applied by a community of computing device users, e.g., tags applied more than a threshold number of times by the community.

Selectable tagging methods described herein may be adapted to include, within tagging suggestions for the digital asset, tags applied to digital assets by a user of the computing device and/or tags applied to digital assets by a community of computing device users. For example, the computing device may connect to a server or database to retrieve community tags to support a variety of the features disclosed herein.

Furthermore, in some embodiments the computing device may present a display group selection UI adapted allow selection of a display group, and to include the digital asset among other digital assets in a selected display group.

Computing devices and computer readable media having instructions implementing the various technologies described herein are also disclosed. Example computer readable media may comprise non-transitory computer readable storage media having computer executable instructions executable by a processor, the instructions that, when executed by the processor, cause the processor to carry out any combination of the various methods provided herein. Example computing devices may comprise a processor, a memory, and a digital asset tagging application configured to carry out the methods described herein. Further aspects and variations of the various embodiments are discussed in detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 is a flow chart illustrating example methods for tagging of assets.

FIG. 2 illustrates an example tagging selection UI adapted to receive a tagging method selection.

FIG. 3 illustrates an example “Last” digital asset tagging UI.

FIG. 4 illustrates an example “Recent” digital asset tagging UI.

FIG. 5 illustrates an example “Batch” digital asset tagging UI.

FIG. 6 illustrates an example “Location” digital asset tagging UI.

FIG. 7 illustrates an example “Situational” digital asset tagging UI.

FIG. 8 illustrates an example “Location Based Batch” digital asset tagging UI.

FIG. 9 illustrates an example “Situational Batch” digital asset tagging UI.

FIG. 10 illustrates an example “Recognition” digital asset tagging UI.

FIG. 11 illustrates an example “Social Network Data” digital asset tagging UI.

FIG. 12 illustrates an example display group selection UI.

FIG. 13 illustrates an example automatic tagging configuration UI.

FIG. 14 illustrates selectable auto-complete suggestions displayed for characters entered into a type tagging field.

FIG. 15 illustrates an example computing device configured with a tagging application to implement the various UI and methods according to this disclosure.

### DETAILED DESCRIPTION

Prior to explaining embodiments of the invention in detail, it is to be understood that the invention is not limited to the details of construction or arrangements of the components and method steps set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

This disclosure provides, inter alia, technologies including devices, computer readable media, and processes for application of meta tagging data (tags) to digital assets such as digital photos, videos, audio files, text files, etc. Disclosed technologies generate tagging suggestions according to a number of different approaches or methods. The different methods for generating tagging suggestions may be selectable by the user, providing for fast and powerful association of relevant tags with digital assets.

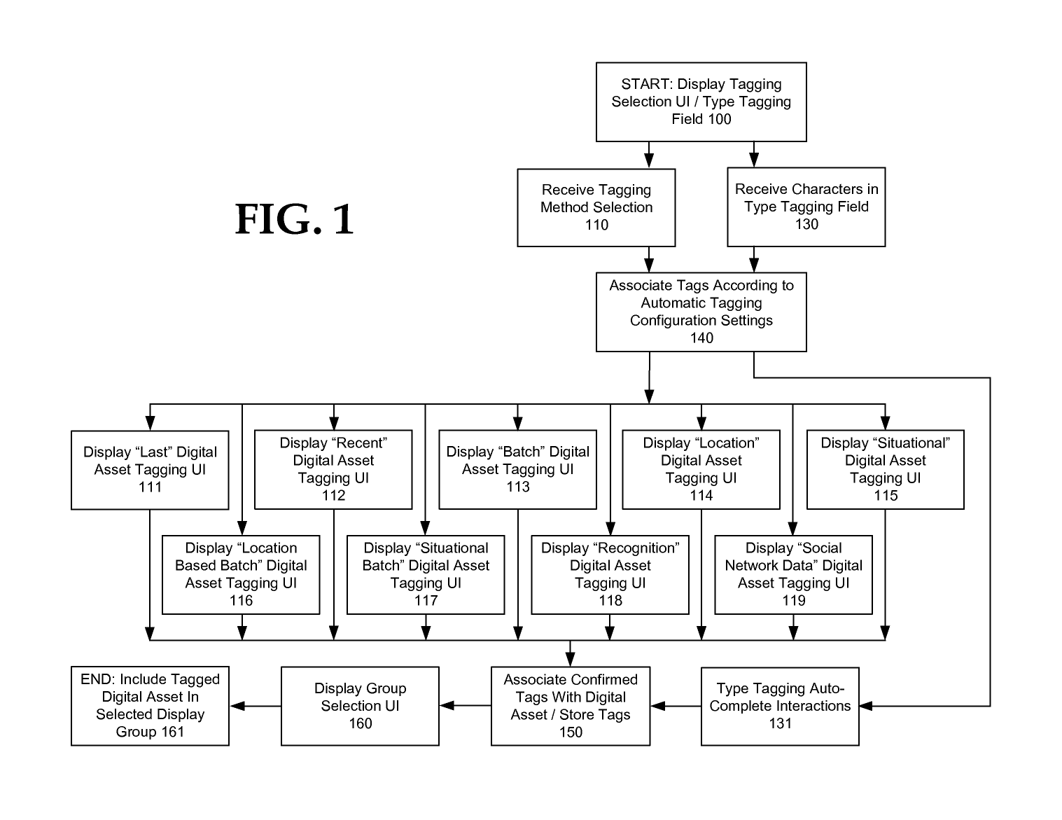

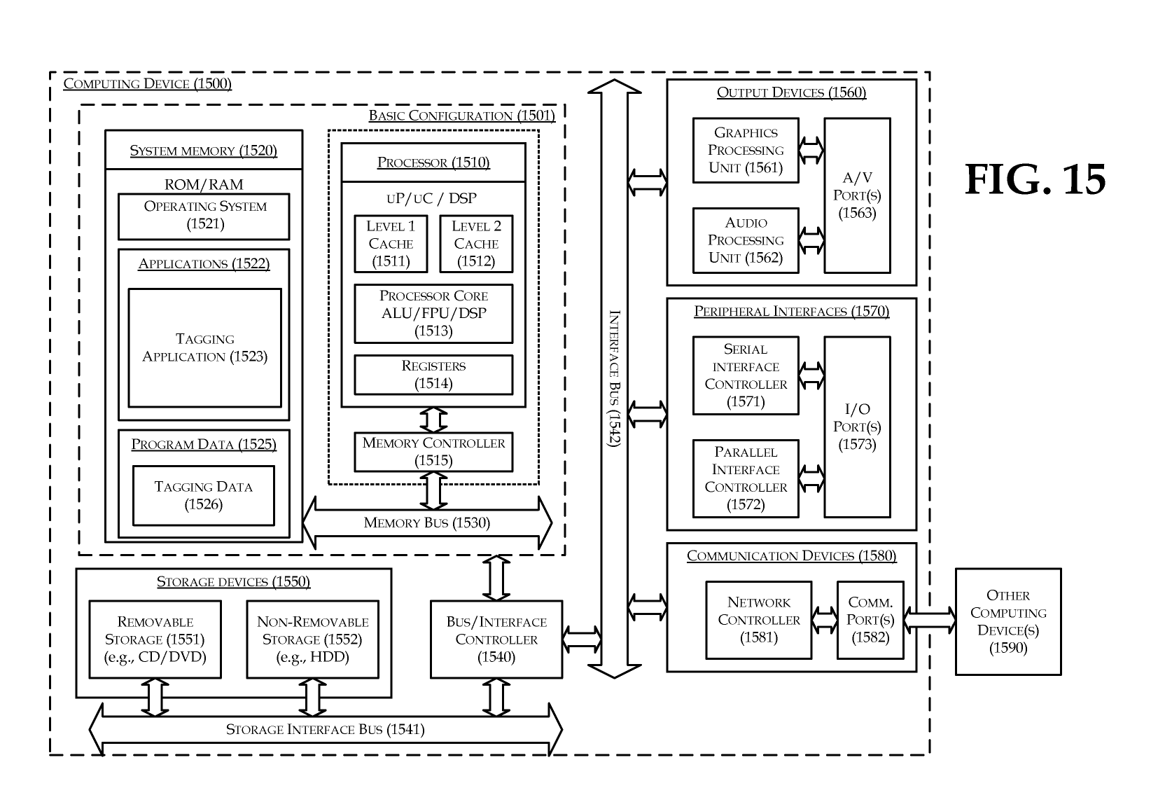

FIG. 1 is a flow chart illustrating example methods for tagging of digital assets, according to some embodiments of this disclosure. Methods according to FIG. 1 may be performed by a computing device configured with digital asset tagging software, e.g., as generally described in connection with FIG. 15. FIG. 1 includes blocks representing operations performed in a method, modules in a computing device and/or instructions as may be recorded on a computer readable medium.

It will be appreciated that blocks illustrated in FIG. 1 may be re-arranged as convenient to suit particular embodiments or that these blocks or portions thereof may be performed concurrently in some embodiments. It will also be appreciated that in some examples, various blocks may be eliminated, divided into additional blocks, and/or combined with other blocks. Each of the blocks illustrated in FIG. 1 is described in further detail below.

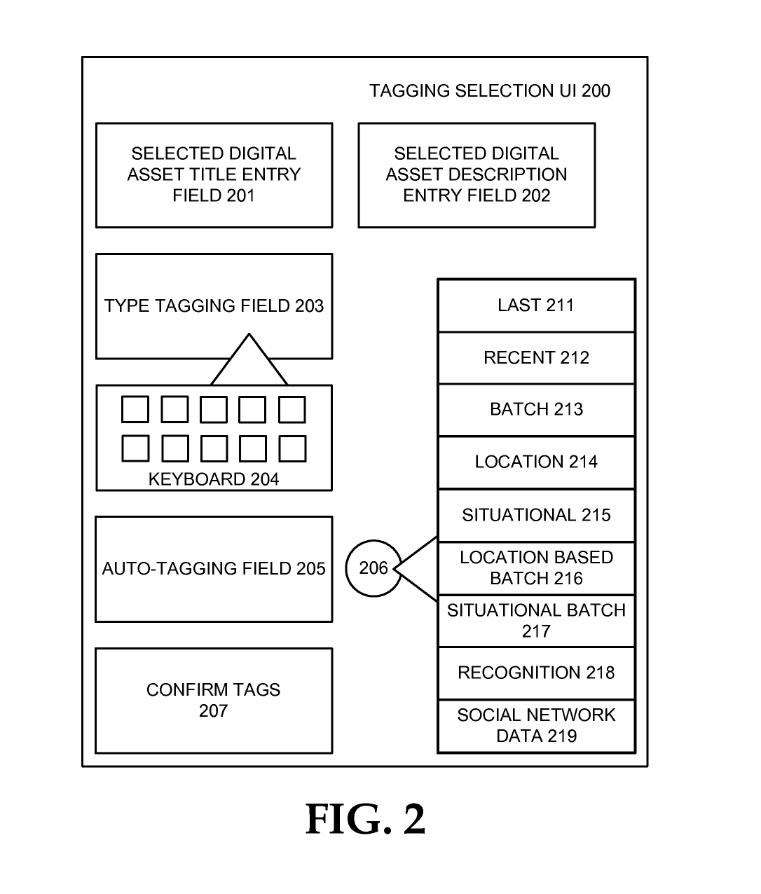

At a “START” block 100, a computing device may display a tagging selection UI and/or type tagging field for applying tags to a selected digital asset. FIG. 2 illustrates an example tagging selection UI adapted to receive a tagging method selection; and the UI illustrated in FIG. 2 also comprises a type tagging field. Tagging selection UI may also be referred to herein as tagging method selection UI or tagging approach selection UI. The tagging selection UI may be adapted to receive a tagging method selection from among a plurality of selectable tagging methods for applying tags to the digital asset. Example selectable tagging methods are described below in connection with blocks 111-119. The type tagging field may be adapted for assisted manual entry of tags for the digital asset, as described herein with reference to blocks 130-131.

In some embodiments, block 100 may be initiated in response to introducing a digital asset into management, e.g. by selecting a digital photograph or other asset, and selecting a menu item directing the computing device to initiate management/tagging of the digital photograph. In some embodiments, block 100 may be initiated for example by opening a digital asset tagging application, and then selecting a digital asset for management. Block 100 may be followed by block 110 when the user engages tagging method selection, or block 100 may be followed by block 130 when the user engages type tagging.

At a “Receive Tagging Method Selection” block 110, the computing device may receive a tagging method selection from among the plurality of selectable tagging methods available from the tagging selection UI. For example, a user may select a tagging approach to be applied for a new digital asset introduced at block 100, and the user's tagging method selection may be received via the tagging selection UI. In response to the received selection, the computing device may be adapted to display a digital asset tagging UI according to any of blocks 111-119, the displayed digital asset tagging UI corresponding to the received tagging method selection. Each of blocks 111-119 comprise displaying a digital asset tagging UI comprising tagging suggestions, and the tagging suggestions may be determined differently for each of blocks 111-119 as described in further detail with reference to blocks 111-119.

In some embodiments, the computing device may be adapted to perform automatic tagging according to block 140 after block 110 and before blocks 111-119. Other embodiments may omit block 140 and/or perform block 140 at a different position in the illustrated flow diagram.

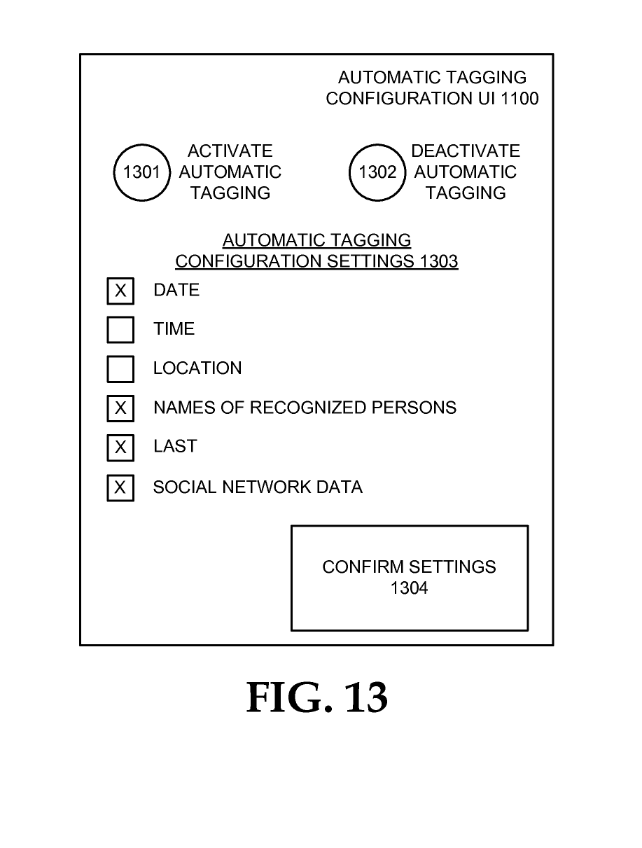

At an “Associate Tags According to Automatic Tagging Configuration Settings” block 140, the computing device may automatically apply any tags to the digital asset in accordance with preset tagging configuration settings. FIG. 13 illustrates an example automatic tagging configuration UI. Prior to performing the blocks illustrated in FIG. 1, the computing device may display an automatic tagging configuration UI adapted to receive an automatic tagging activation or deactivation, and/or one or more automatic tagging configuration settings. The automatic tagging activation or deactivation may for example activate or deactivate auto-tagging of digital assets at block 140.

The one or more automatic tagging configuration settings may configure tags to be applied to digital assets automatically at block 140. Automatic tagging configuration settings may comprise, e.g., at least one of: a date tag setting, a time tag setting, a location tag setting, and a names of recognized persons tag setting. Any other automatic tagging configuration settings may be included as will be appreciated, including, e.g., elapsed time, Global Positioning System (GPS) coordinates, other devices in proximity, names of people based on image recognition, description of objects based on image recognition, outdoor temperature, relative humidity, speed, acceleration, elevation, foot candles or other measures of light intensity, and others. The computing device may automatically associate, at block 140, one or more tags with the digital asset according to any activated automatic tagging configuration settings, e.g., when automatic tagging is activated via the automatic tagging configuration UI.

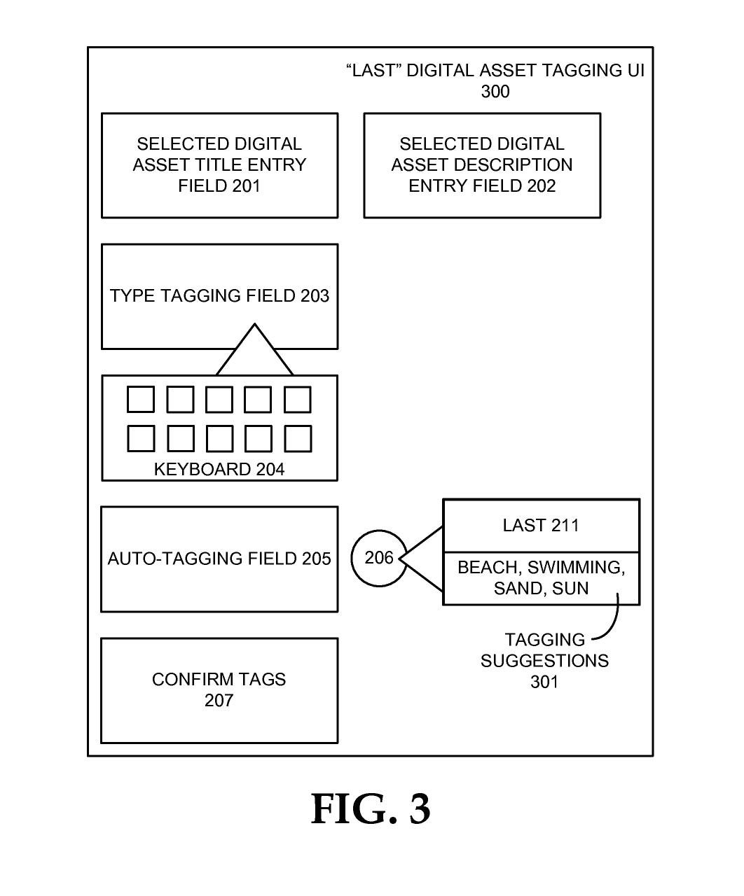

The computing device may perform a “Display “Last” Digital Asset Tagging UI” block 111 in response to receiving a selection of a “Last” tagging method at block 110. FIG. 3 illustrates an example “Last” digital asset tagging UI. A “Last” digital asset tagging UI may include, within tagging suggestions for the digital asset, tags applied to an immediate previous tagged digital asset. The computing device may receive any user modifications of the included tagging suggestions, and user confirmation of one or more modified or unmodified tags from among the tagging suggestions displayed in the digital asset tagging UI. Block 111 may be followed by block 150.

Blocks 111-119 may generally operate by including, within tagging suggestion, tags and/or sets of tags applied to previous digital assets, wherein the previously applied tags and/or sets of tags may be retrieved from a tagging suggestions database. The tagging suggestions database may also include other data such as user identification, computing device identification, time of use of a tag or set of tags, numbers of times a tag or set of tags occurs in the database and wide variety of other information as appropriate to support the various tagging methods described herein. The tagging suggestions database may include tags applied by one or more users. For example, to support use of tags applied by a community of multiple users, computing devices may synchronize with a tagging suggestions database server. Tagging suggestions may be retrieved from the tagging suggestions database based on the selected tagging method. For example, to support the “Last” tagging method, a most recently used tag or set of tags applied to any digital asset by the user of the computing device may be retrieved from the tagging suggestions database, and the retrieved tags may be presented in a UI as one or more tagging suggestions.

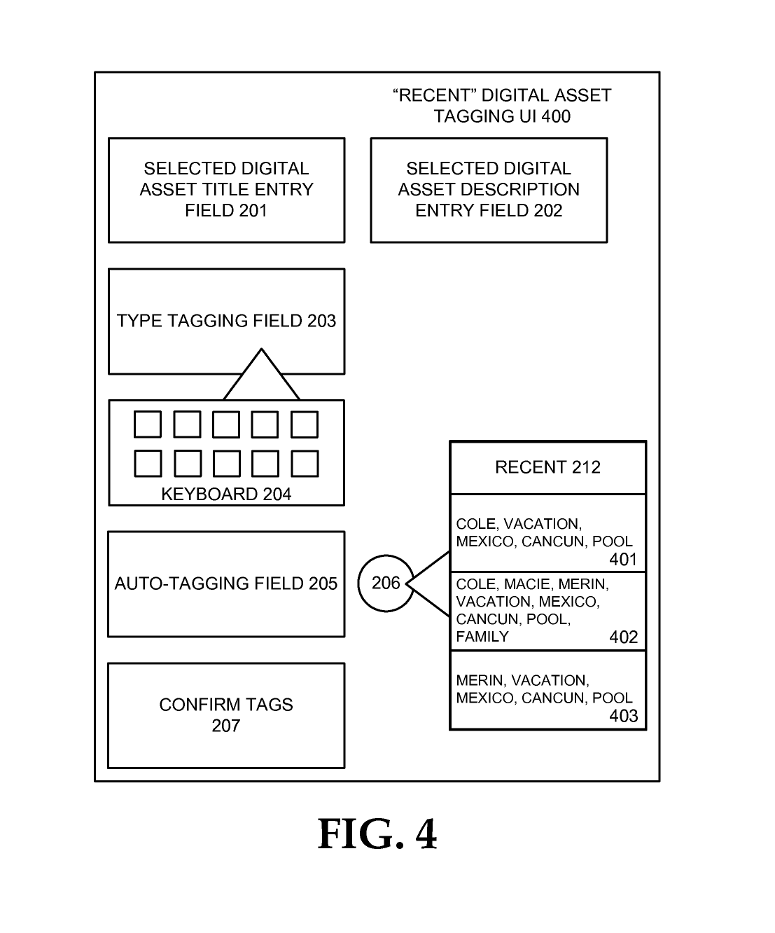

The computing device may perform a “Display “Recent” Digital Asset Tagging UI” block 112 in response to receiving a selection of a “Recent” tagging method at block 110. FIG. 4 illustrates an example “Recent” digital asset tagging UI. A “Recent” digital asset tagging UI may display one or more selectable recent tag groups, each selectable recent tag group comprising tagging suggestions from tag groups applied to one or more previous tagged digital assets.

In some embodiments, to support “Recent” tagging methods, a set of two or more most recently used tags or sets of tags applied to any digital assets by the user of the computing device may be retrieved from the tagging suggestions database. Each member of the set may be presented as a selectable recent tag group.

The computing device may receive a selection of a selectable recent tag group, and the computing device may receive any user modifications of the corresponding tagging suggestions, and user confirmation of one or more modified or unmodified tags from among the tagging suggestions displayed in the digital asset tagging UI. Block 112 may be followed by block 150.

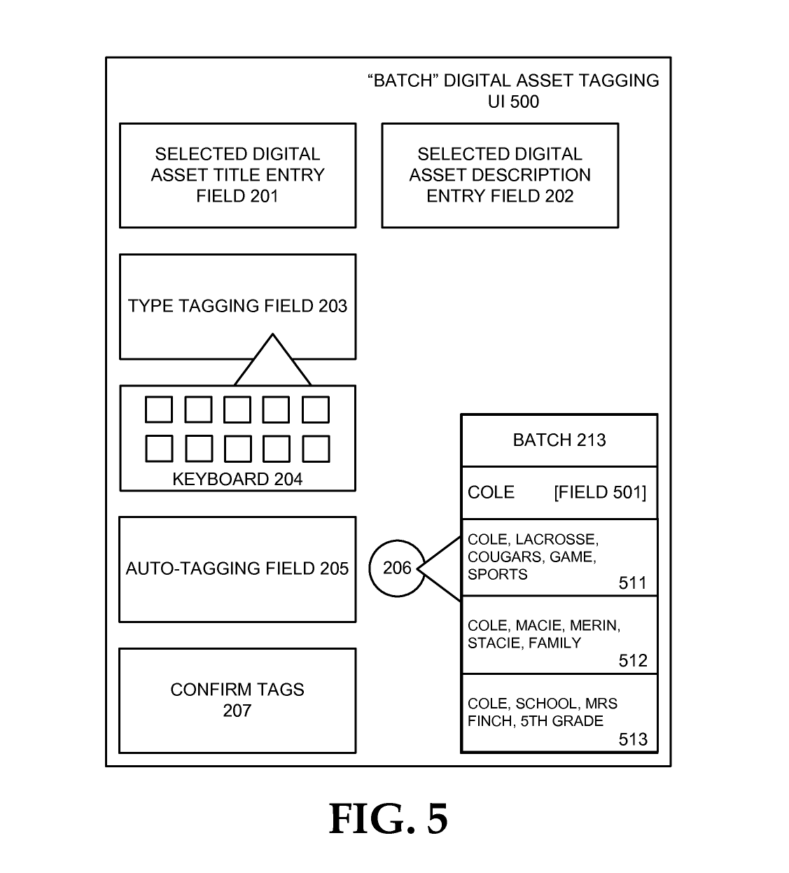

The computing device may perform a “Display “Batch” Digital Asset Tagging UI” block 113 in response to receiving a selection of a “Batch” tagging method at block 110. FIG. 5 illustrates an example “Batch” digital asset tagging UI. A “Batch” digital asset tagging UI may display one or more selectable common tag groups corresponding to one or more user-entered tags, each selectable common tag group comprising tagging suggestions from tag groups applied to multiple tagged digital assets.

In some embodiments, to support the “Batch” tagging method, a set of two or more most commonly used tags or sets of tags applied to any digital asset by either the user of the computing device, or by a community of computing device users (e.g., users of computing devices equipped with a digital asset tagging application), and corresponding to one or more user-entered tags, may be retrieved from the tagging suggestions database by searching the tagging suggestions database for popular tags or sets of tags that also match user-entered tags or partial tags. The user-entered tags or partial tags may comprise, e.g., tags received via the “Batch” digital asset tagging UI as the user types in tags. Each retrieved tag and/or set of tags may be presented as a selectable common tag group.

The computing device may receive a selection of a selectable common tag group, and the computing device may receive any user modifications of the corresponding tagging suggestions, and user confirmation of one or more modified or unmodified tags from among the tagging suggestions displayed in the digital asset tagging UI. Block 113 may be followed by block 150.

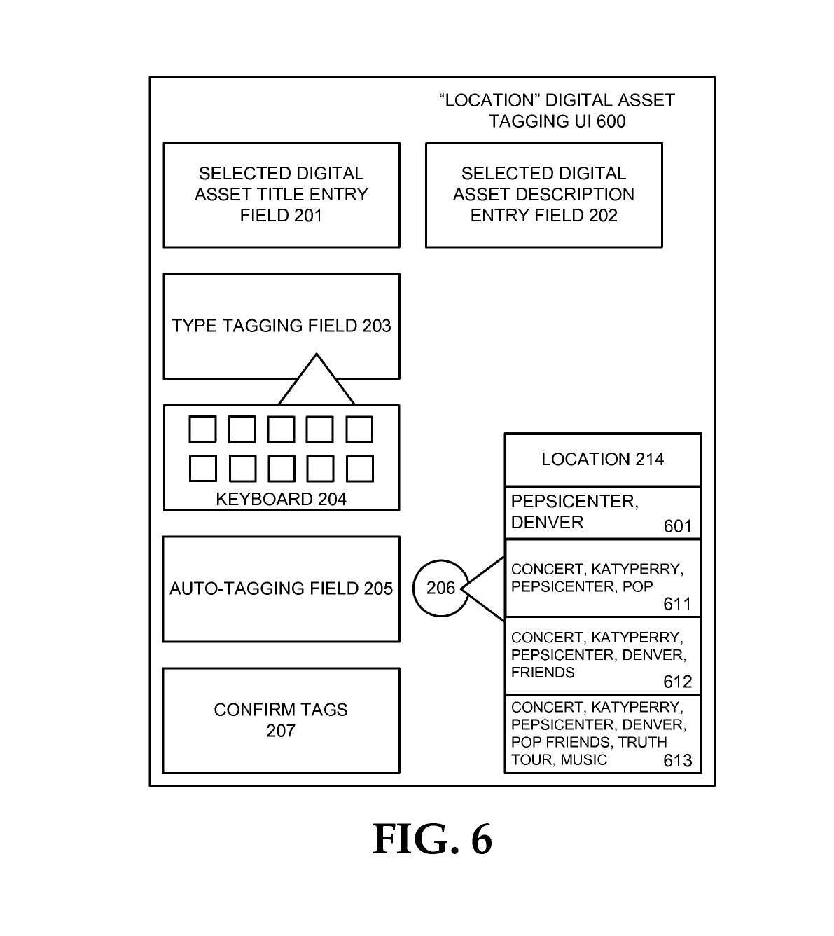

The computing device may perform a “Display “Location” Digital Asset Tagging UI” block 114 in response to receiving a selection of a “Location” tagging method at block 110. FIG. 6 illustrates an example “Location” digital asset tagging UI.

A “Location” digital asset tagging UI may include, within tagging suggestions for the digital asset, tags applied to digital assets at a location of the computing device.

In some embodiments, to support the “Location” tagging method, the tagging suggestions database may record locations associated with tagged digital assets, e.g., computing device locations at times when tags are applied to digital assets, or computing device locations at times assets were acquired, e.g., when a photograph was taken. Tags previously applied by the user of the computing device, or by a community of computing device users, and associated with a previously recorded location matching a current computing device location, may be retrieved from the tagging suggestions database and may be presented as one or more tagging suggestions.

The computing device may receive any user modifications of the tagging suggestions, and user confirmation of one or more modified or unmodified tags from among the tagging suggestions displayed in the digital asset tagging UI. Block 114 may be followed by block 150.

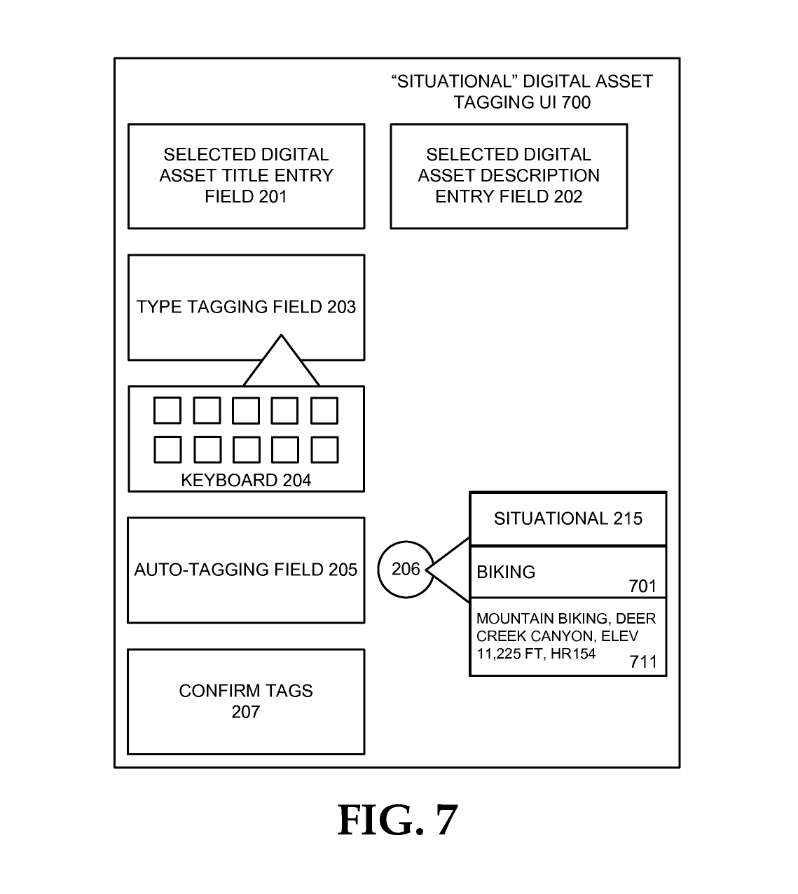

The computing device may perform a “Display “Situational” Digital Asset Tagging UI” block 115 in response to receiving a selection of a “Situational” tagging method at block 110. FIG. 7 illustrates an example “Situational” digital asset tagging UI. A “Situational” digital asset tagging UI may include tags identifying situational phenomena detected by the computing device within tagging suggestions for the digital asset.

In some embodiments, to support the “Situational” tagging method, the computing device may detect situational phenomena and generate tagging suggestions based on detected phenomena, without necessarily consulting the tagging suggestions database. In some embodiments, the “Situational” tagging method may make use of the tagging suggestions database. For example, the tagging suggestions database may record detected situational phenomena associated with tagged digital assets, e.g., situational phenomena detected by computing devices at times when tags are applied to digital assets, or situational phenomena detected by computing devices at times assets were acquired, e.g., when a photograph was taken. Tags previously applied by the user of the computing device, or by a community of computing device users, and associated with previously recorded situational phenomena matching current detected situational phenomena may be retrieved from the tagging suggestions database and may be presented as one or more tagging suggestions.

The computing device may receive any user modifications of the tagging suggestions, and user confirmation of one or more modified or unmodified tags from among the tagging suggestions displayed in the digital asset tagging UI. Block 115 may be followed by block 150.

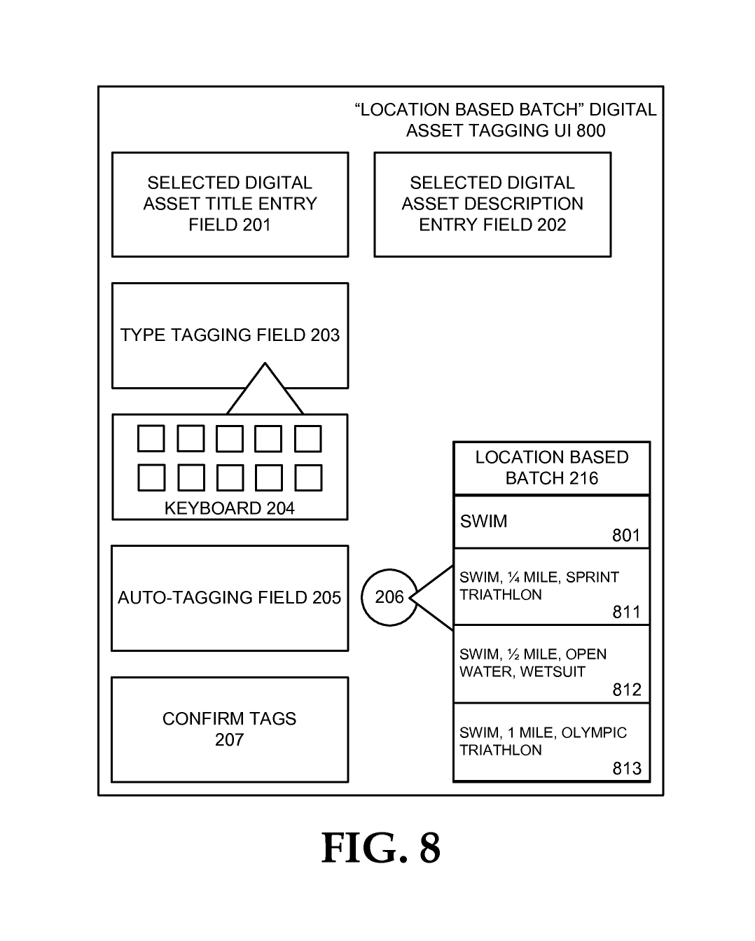

The computing device may perform a “Display “Location Based Batch” Digital Asset Tagging UI” block 116 in response to receiving a selection of a “Location Based Batch” tagging method at block 110. FIG. 8 illustrates an example “Location Based Batch” digital asset tagging UI. A “Location Based Batch” digital asset tagging UI may display one or more selectable common tag groups corresponding to one or more user-entered tags and a location of the computing device, each selectable common tag group comprising tagging suggestions from tag groups applied to multiple tagged digital assets at the location of the computing device.

In some embodiments, to support the “Location Based Batch” tagging method, a set of two or more most commonly used tags or sets of tags applied to any previous digital assets by either the user of the computing device, or by a community of computing device users (e.g., users of computing devices equipped with a digital asset tagging application), and corresponding to one or more user-entered tags as well as matching a current location of the computing device, may be retrieved from the tagging suggestions database by searching the tagging suggestions database for popular tags or sets of tags that also match user-entered tags or partial tags. The user-entered tags or partial tags may comprise, e.g., tags received via the “Location Based Batch” digital asset tagging UI as the user types in tags. Each retrieved tag or set of tags may be presented as a selectable common tag group.

The computing device may receive a selection of a selectable common tag group, and the computing device may receive any user modifications of the corresponding tagging suggestions, and user confirmation of one or more modified or unmodified tags from among the tagging suggestions displayed in the digital asset tagging UI. Block 116 may be followed by block 150.

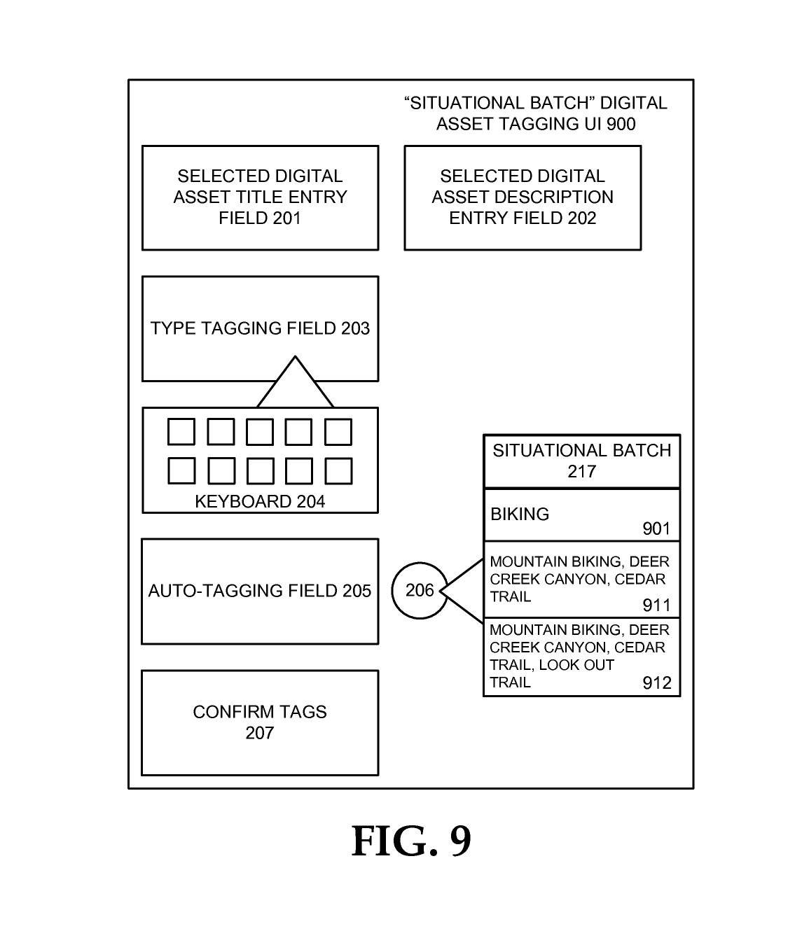

The computing device may perform a “Display “Situational Batch” Digital Asset Tagging UI” block 117 in response to receiving a selection of a “Situational Batch” tagging method at block 110. FIG. 9 illustrates an example “Situational Batch” digital asset tagging UI. A “Situational Batch” digital asset tagging UI may display one or more selectable common tag groups corresponding to one or more user-entered tags and/or detected situational phenomena, each selectable common tag group comprising tagging suggestions from tag groups applied to multiple tagged digital assets exhibiting the detected situational phenomena.

In some embodiments, to support “Situational Batch” tagging methods, a set of two or more most commonly used tags or sets of tags applied to any previous digital assets by either the user of the computing device, or by a community of computing device users (e.g., users of computing devices equipped with a digital asset tagging application), and corresponding to one or more currently detected situational phenomena, may be retrieved from the tagging suggestions database by searching the tagging suggestions database for popular tags or sets of tags that also match the currently detected situational phenomena. Each retrieved tag or sets of tags may be presented as a selectable common tag group.

The computing device may receive a selection of a selectable common tag group, and the computing device may receive any user modifications of the corresponding tagging suggestions, and user confirmation of one or more modified or unmodified tags from among the tagging suggestions displayed in the digital asset tagging UI. Block 117 may be followed by block 150.

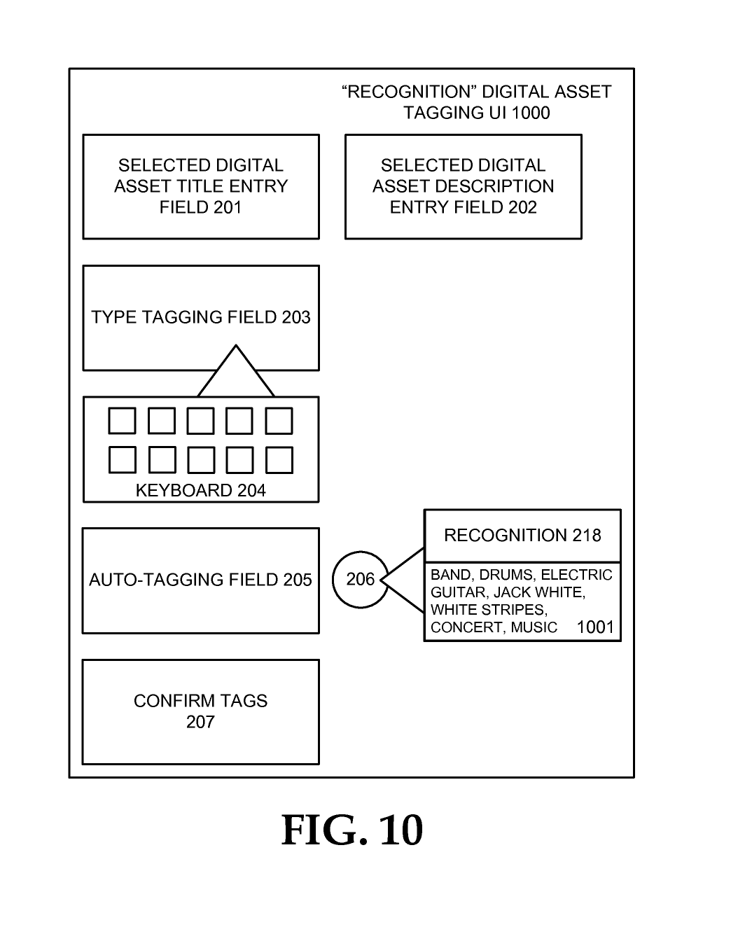

The computing device may perform a “Display “Recognition” Digital Asset Tagging UI” block 118 in response to receiving a selection of a “Recognition” tagging method at block 110. FIG. 10 illustrates an example “Recognition” digital asset tagging UI. A “Recognition” digital asset tagging UI may include, within tagging suggestions for the digital asset, tags that identify one or more objects represented within the digital asset.

In some embodiments, to support the “Recognition” tagging method, the tagging suggestions database, or a separate recognition database, may include recognition data, e.g., object recognition data, and the computing device may perform recognition processes on digital assets, e.g., object recognition on photographs. Tagging suggestions corresponding to recognized objects, such as names of persons matching recognized faces or other physical characteristics, or descriptions of objects such as “car,” “house,” “bicycle,” “person,” “dog,” etc., may be retrieved from the tagging suggestions database, or recognition database, and may be presented as one or more tagging suggestions.

The computing device may receive any user modifications of the tagging suggestions, and user confirmation of one or more modified or unmodified tags from among the tagging suggestions displayed in the digital asset tagging UI. Block 118 may be followed by block 150.

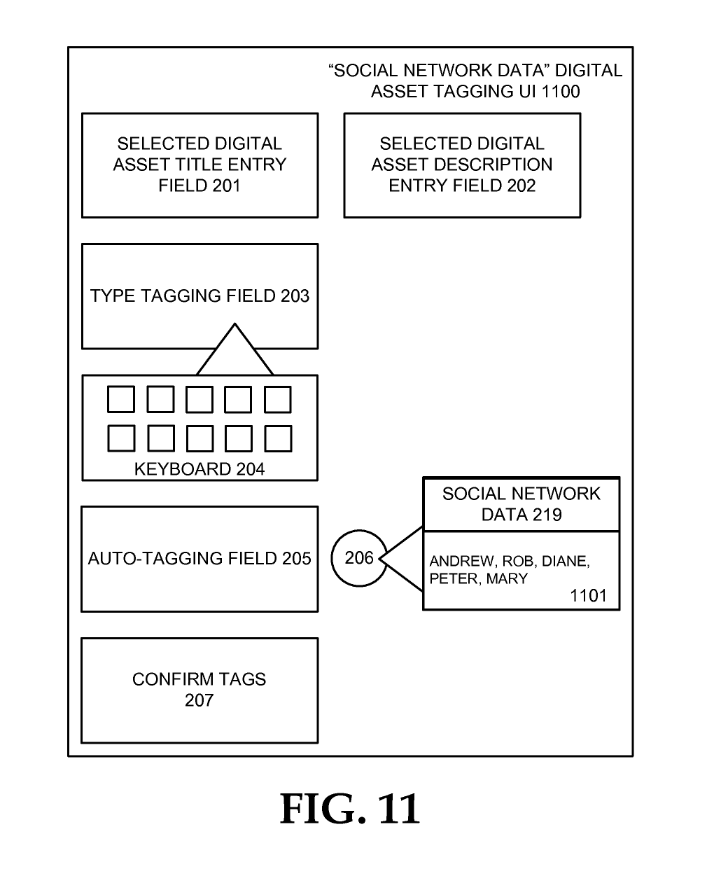

The computing device may perform a “Display “Social Network Data” Digital Asset Tagging UI” block 119 in response to receiving a selection of a “Social Network Data” tagging method at block 110. FIG. 11 illustrates an example “Social Network Data” digital asset tagging UI. A “Social Network Data” digital asset tagging UI may include, within tagging suggestions for the digital asset, tags extracted from social network data associated with the digital asset.

In some embodiments, to support “Social Network Data” tagging methods, social network data that may be associated with the digital asset, such as an identification of a social network username that identifies, e.g., a user of a FACEBOOK® or TWITTER® account, may be retrieved and presented as one or more tagging suggestions. Social network data may be embedded in metadata of some digital assets, and may be retrieved from such metadata, or social network data may be determined when downloading the digital asset from a social network, or from other information. Embodiments may also include, along with tagging suggestions retrieved from social network data, tagging suggestions associated with the social network data in the tagging suggestions database. For example, embodiments may include, within tagging suggestions, tags that may be frequently applied, by the user of the computing device, or by a community of computing device users, to digital assets along with the tags retrieved from social network data associated with the digital asset.

The computing device may receive any user modifications of the tagging suggestions, and user confirmation of one or more modified or unmodified tags from among the tagging suggestions displayed in the digital asset tagging UI. Block 118 may be followed by block 150.

Any of the UI displayed pursuant to blocks 111-119 may be adapted to support manual user modifications of displayed tagging suggestions. Manual modification may comprise adding, editing, or deleting one or more tagging suggestions. For example, tagging suggestions may be presented in a field that supports manual adding, editing, and deleting tags from the tagging suggestions.

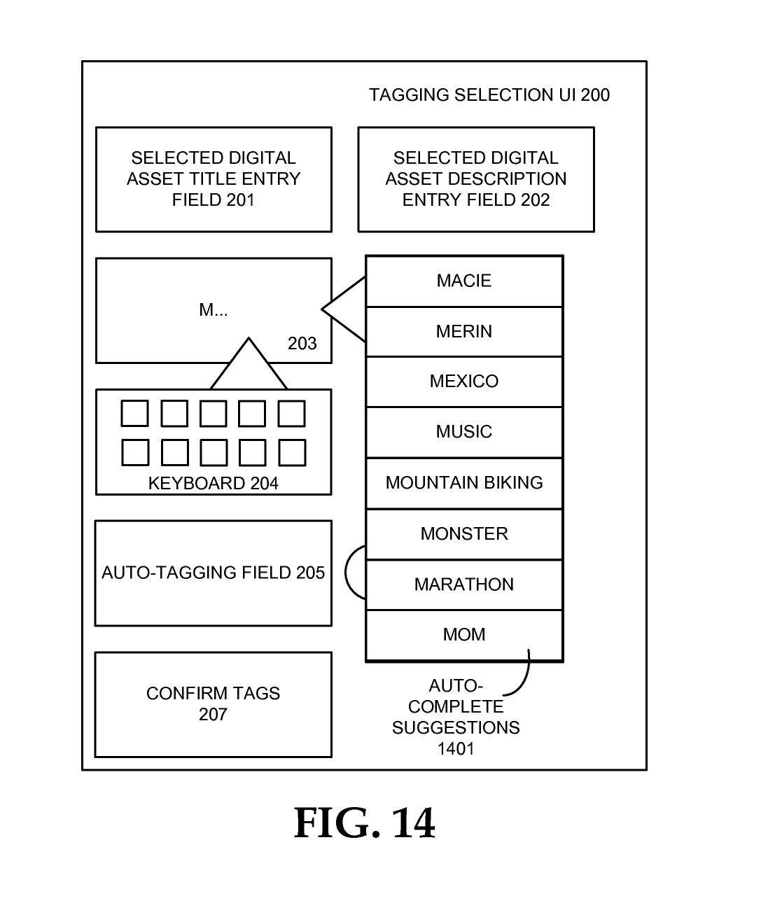

At a “Receive Characters in Type Tagging Field” block 130, the computing device may receive user entry of characters in the type tagging field, e.g., as the user types in a tag for the digital asset. The type tagging field may be adapted for assisted manual entry of tags for the digital asset. For example, the computing device may be adapted to display selectable auto-complete suggestions for characters entered into the type tagging field. The selectable auto-complete suggestions may include suggestions from a database of previously applied tags, such as the tagging suggestions database described herein. FIG. 14 illustrates an example display of selectable auto-complete suggestions.

In some embodiments, selectable auto-complete suggestions from tags applied by a community of computing device users may comprise tags applied more than a threshold number of times by the community of computing device users, e.g., tags applied more than 5,000 times, or any other threshold number of times. Block 130 may be followed by block 131.

At a “Type Tagging Auto-Complete Interactions” block 131, the computing device may for example connect to the tagging suggestions database to retrieve auto-complete suggestions, display the auto-complete suggestions, and receive auto-complete selections. If none of the auto-complete suggestions are selected, the computing device may instead receive any tags entered in full by the user who opts not to select auto-complete suggestions. Whether or not auto-complete suggestions are selected, the computing device may receive one or more selected or otherwise entered tags for the digital asset in the type tagging field, and the computing device may receive user confirmation of one or more selected or otherwise entered tags. Block 131 may be followed by block 150.

At an “Associate Confirmed Tags with Digital Asset/Store Tags” block 150, the computing device may associate with the digital asset one or more tags received via blocks 111-119, e.g., confirmed tagging suggestions received via blocks 111-119, or one or more tags received via blocks 130-131, e.g., selected auto-complete suggestions received via blocks 130-131. The computing device may associate tags with the digital asset via any number of techniques. In some embodiments, the computing device may include the tags in digital asset metadata. In some embodiments, the computing device may update a database comprising digital asset identifiers to include tags associated with the digital asset identifiers. The computing device may store the one or more tags associated with the digital asset, e.g. by writing the tags into digital asset metadata or into a database. In some embodiments, associating and storing tags may be accomplished in a single operation. Block 150 may be followed by block 160.

At a “Display Group Selection UI” block 160, the computing device may display a display group selection UI comprising one or more selectable display groups, and adapted to receive a display group selection. For example, embodiments may comprise one or more selectable “digital fridge” display groups, comprising representations of refrigerators to which photographs, notes, videos, etc. may be added. Such display groups may be shared among configurable groups of users of a digital asset tagging application, e.g., display groups may be shared among family members or groups of friends. Upon receiving a display group selection from the display group selection UI, block 160 may be followed by block 161.

At an “Include Digital Asset in Selected Display Group” block 161, the computing device may include the tagged digital asset among other digital assets in a selected display group. Embodiments may store the digital asset or a reference to the digital asset in the display group or display group data structure, to make the digital asset visible within the display group to whomever may have access to the selected display group.

FIG. 2 illustrates an example tagging selection UI 200 adapted to receive a tagging method selection, according to some embodiments of this disclosure. Tagging selection UI 200 comprises a selected digital asset title entry field 201, a selected digital asset description entry field 202, a type tagging field 203, a keyboard 204, an auto-tagging field 205, a control 206 for accessing tagging method selection controls 211-219, and a confirm tags control 207. Tagging method selection controls 211-219 include last 211, recent 212, batch 213, location 214, situational 215, location based batch 216, situational batch 217, recognition 218, and social network data 219.

In some embodiments, tagging steps according to various tagging methods disclosed herein may begin with a tagging selection UI such as illustrated in FIG. 2. In some embodiments, a computing device may be adapted to display tagging selection UI 200 for example in response to user selection of a digital asset, such as a digital photograph, and selecting a control to apply tags to the digital asset. In some embodiments, the computing device may be adapted to display tagging selection UI 200 for example in response to introduction of a new digital asset into the computing device, such as by taking a picture with the device, recording a video, or transferring a file into device memory. Tagging selection UI 200 is displayed for tagging of a particular selected or otherwise introduced digital asset or group of digital assets. In some embodiments, the digital asset to be tagged may be displayed or otherwise identified in tagging selection UI 200, such as by displaying a thumbnail of a digital photograph or video to be tagged.

Selected digital asset title entry field 201 may be adapted to receive a title for the selected digital asset, and selected digital asset description entry field 202 may be adapted to receive a description for the selected digital asset. For example, in response to user touch or other selection of field 201 or field 202, UI 200 may display a keyboard such as 204 for the user to type in a free text title or description.

In some embodiments, type tagging field 203 may be included in UI 200. Type tagging field 203 may be adapted for assisted manual entry of tags for the digital asset. The computing device may be adapted to display selectable auto-complete suggestions for characters entered into the type tagging field 203 for assisted manual entry of tags, as illustrated for example in FIG. 14. For example, in response to user touch or other selection of field 203, UI 200 may display a keyboard such as 204 for the user to type in free text. The computing device may be adapted to retrieve and display selectable auto-complete suggestions including suggestions from a database of previously applied tags as the user types characters into field 203. UI 200 may be adapted to display selected auto-complete suggestions in type tagging field 203. In some embodiments, type tagging field 203 may be combined with auto-tagging field 205, so that fields 203 and 205 are presented as a single field, as described herein.

Tagging selection UI 200 may be adapted to display tagging method selection controls 211-219 in response to user touch or other selection of auto-tagging field 205 or control 206. Tagging method selection controls 211-219 represent a plurality of selectable tagging methods for applying tags to the digital asset. The plurality of selectable tagging methods may comprise one or more of a last 211, a recent 212, a batch 213, a location 214, a situational 215, a location based batch 216, a situational batch 217, a recognition 218, and/or a social network data 219 tagging method, each of which is described in detail herein. Any selected tagging method may result displaying a corresponding digital asset tagging UI from which tagging suggestions may be selected. Selected tagging suggestions may be displayed in auto-tagging field 205. Embodiments may also support adding, deleting, and modifying tagging suggestions in auto-tagging field 205, e.g., by UI 200 displaying a keyboard such as 204 for modifying field 205 in response to user touch or other selection of auto-tagging field 205.

Auto-tagging field 205 and type tagging field 203 may be displayed as a single combined field in some embodiments. For example, type tagging field 203 as described above may be combined with a control such as 206 to access the plurality of selectable tagging methods. Selected tagging suggestions accessed via a selected tagging method may be displayed and modified along with any selected auto-complete suggestions in the type tagging field 203.

Confirm tags control 207 may be adapted to receive a user confirmation of one or more tags displayed in the digital asset tagging UI 200, for example, a user confirmation of tags entered in the type tagging field 203 and/or tagging suggestions displayed in the auto-tagging field 205, as optionally modified using keyboard 204. The computing device may be adapted to associate, with the digital asset, the one or more tags in fields 203 and 205, as well as any title entered in field 201 or description entered in field 202, in response to a received selection of the confirm tags control 207. The computing device may be adapted to store the one or more tags associated with the digital asset, the title, and/or the description, e.g., as metadata associated with the digital asset, or using any other storage technique.

FIG. 3 illustrates an example “Last” digital asset tagging UI 300, according to some embodiments of this disclosure. “Last” digital asset tagging UI 300 may comprise selectable tagging suggestions 301 according to “Last” digital asset tagging methods disclosed herein, optionally in combination with elements 201-207 introduced in FIG. 2.

In example “Last” digital asset tagging methods, tags applied to an immediate previous tagged digital asset may be included within tagging suggestions 301 for the digital asset being tagged. Digital assets are often captured in a “series” and can be tagged based on a last or immediate previous asset captured. Embodiments may include tagging suggestions 301 in tags for the digital asset, e.g., in auto-tagging field 205, automatically or in response to user selection of selectable tagging suggestions 301.

In an example “Last” digital asset tagging scenario, a parent on vacation in Mexico is capturing digital assets at the pool of their son Cole. The parent is taking multiple photos and videos and after capturing the first digital asset, they tag the asset with the following eight meta-data tags: Cole; Vacation; Cancun; Mexico; Pool; July; 2012; Family.

The parent may likely continue capturing assets that can use the exact same meta-data tags, and the UI 300 may be used to easily apply these tags to additional digital assets. In some embodiments, UI 300 may be adapted to include a control whereby the “Last” function may be automatically applied to all future assets, until turned off or until they apply different meta-data tags to a digital asset. This feature can be initiated manually for each asset or can be an automatic function that is turned on/off. After selecting tagging suggestions 301, the user can modify the tagging suggestions entered in auto-tagging field 205 before saving the digital asset with the tags assigned via the UI 300.

FIG. 4 illustrates an example “Recent” digital asset tagging UI 400, according to some embodiments of this disclosure. “Recent” digital asset tagging UI 400 may comprise selectable recent tag groups such as 401, 402, and/or 403 according to “Recent” digital asset tagging methods disclosed herein, optionally in combination with elements 201-207 introduced in FIG. 2.

In example “Recent” digital asset tagging methods, one or more selectable recent tag groups such as 401, 402, and/or 403 may be displayed, each selectable recent tag group 401, 402, and 403 comprising tagging suggestions from tag groups applied to one or more previous tagged digital assets. In some embodiments, “Recent” digital asset tagging UI 400 may be configured to support selection of any of the “Recent” meta-data tag groups that users would like to apply to the current digital asset. After selection of a tag group 401, 402, or 403, UI 400 may be configured to place the tagging suggestions from the selected tag group into auto-tagging field 205, where the user can modify the tagging suggestions before saving the digital asset with the tags assigned via the UI 400.

Many times a user might be capturing assets in circumstances wherein the user is going back and forth between a handful of meta-data tag groups. The “Recent” function may allow the user and/or the computing device to quickly and easily select between a plurality of the user's recent tag groups. In some embodiments, automatic recent tagging functions may be set to automatically select a recent tag group. For example, automatic recent tagging may comprise recognition of objects in the digital asset, identification of objects and/or names of people recognized within the digital asset, and selection of an appropriate recent tag group including the identified names. Embodiments may also automatically add new tags to a selected recent tag group, e.g., based on any new persons recognized in the digital asset.

In an example “Recent” digital asset tagging scenario, a parent on vacation in Mexico may be capturing assets at the pool of their son Cole and daughters Macie and Merin. The parent may take multiple photos and videos including varying combinations of their children. As they create a new tag group for a digital asset, the newly created tag group may be added among the selectable “Recent” tag groups 401, 402, and 403, allowing the parent to quickly and easily select between any recently applied tag group.

Below are examples of selectable tag groups that may be presented in UI 400, after the parent has created several tag groups:
Cole, Vacation, Mexico, Cancun, Pool
Cole, Macie, Merin, Vacation, Mexico, Cancun, Pool, Family
Merin, Vacation, Mexico, Cancun, Pool
Macie, Vacation, Mexico, Cancun, Pool
Macie, Merin, Vacation, Mexico, Cancun, Pool

The parent may continue capturing assets, and may select one or more of their “Recent” meta-data tag groups for any additional captured assets. The “Recent” function allows the user to quickly and easily select appropriate tag groups to apply to future assets. After selection of a tag group, UI 400 may place tagging suggestions from the selected tag group into auto-tagging field 205, where the user can modify the tagging suggestions and save the digital asset with the tags assigned via the UI 400.

FIG. 5 illustrates an example “Batch” digital asset tagging UI, according to some embodiments of this disclosure. “Batch” digital asset tagging UI 500 may comprise selectable common tag groups 511, 512, and/or 513 according to “Batch” digital asset tagging methods disclosed herein, optionally in combination with elements 201-207 introduced in FIG. 2.

In example “Batch” digital asset tagging methods, one or more selectable common tag groups such as 511, 512, and/or 513 may be displayed, the common tag groups 511, 512, and/or 513 corresponding to one or more user-entered tags such as a tag entered in field 501. Each selectable common tag group 511, 512, and/or 513 may comprise tagging suggestions from tag groups applied to multiple tagged digital assets. For example, UI 500 may display selectable popular tag groups that match user-entered tags, entered in field 501. In some embodiments, auto-tagging field 205 and/or type tagging field 203 may serve as field 501 when batch tagging is selected. After selection of a tag group 511, 512, or 513, UI 500 may be configured to place the tagging suggestions from the selected tag group into auto-tagging field 205, where the user can modify the tagging suggestions before saving the digital asset with the tags assigned via the UI 500.

With “Batch” tagging, as the user types in tags for the digital asset, e.g., in field 501, the UI 500 may be adapted to find similar popular batches, or common tag groups 511, 512, and/or 513, that contain the initial tags entered. The user or the computing device can choose from among the displayed common tag groups 511, 512, and/or 513. The displayed common tag groups 511, 512, and/or 513 may comprise tags applied by a community, e.g., all users of a digital asset tagging application, or the user and his or her connections in a social network graph, or the displayed common tag groups 511, 512, and/or 513 may comprise tags applied by the user of the computing device, or both.

In an example “Batch” digital asset tagging scenario, a parent may type “Cole” in field 501. UI 500 may be adapted display popular/common tag groups available that the parent or the computing device have used in the past with the same tag “Cole” within the tag group. Example common tag groups may include:
Cole, Lacrosse, Cougars, Game, Sports
Cole, Macie, Merin, Stacie, Family
Cole, School, MrsFinch, 5thGrade
Cole, Funny
Cole, Friends, Mitchell
Cole, Grandparents

After selection of a common tag group, UI 500 may place tagging suggestions from the selected tag group into auto-tagging field 205, where the user can modify the tagging suggestions and save the digital asset with the tags assigned via the UI 500.

FIG. 6 illustrates an example “Location” digital asset tagging UI, according to some embodiments of this disclosure. “Location” digital asset tagging UI 600 may comprise selectable tagging suggestions 611, 612, 613 according to “Location” digital asset tagging methods disclosed herein, optionally in combination with elements 201-207 introduced in FIG. 2.

In example “Location” digital asset tagging methods, tags previously applied to digital assets at a location of the computing device, or in some embodiments, tags previously applied to digital assets at a location specified by the user, may be included within tagging suggestions for the current digital asset. Tagging suggestions may be presented in multiple selectable tag groups such as 611, 612, and/or 613 in some embodiments, each tag group comprising one or more tagging suggestions, or tagging suggestions may be presented in a single tag group.

In some embodiments, the computing device may use a device location as determined by GPS or other positioning technology, or a location specified by the user via a field such as 601, to retrieve tagging suggestions such as 611, 612, and/or 613 comprising tags previously applied to digital assets at the determined or user-specified location. After selection of a tag or tag group such as 611, 612, or 613, UI 600 may be configured to place the tagging suggestions from the selected tag group into auto-tagging field 205, where the user can modify the tagging suggestions before saving the digital asset with the tags assigned via the UI 600.

In some embodiments UI 600 may be configured to retrieve popular tags for the specific current location of the computing device. The user or the computing device may easily select descriptive location-based tags from the retrieved tagging suggestions. For example, if a user and computing device were in Seattle, Wash., near the space needle, Experience Music Project, and monorail terminal, tagging suggestions may include: Seattle, SpaceNeedle, ExperienceMusicProject, SeattleCenter, SeattleMonorail, WashingtonState, PacificNorthwest, WestCoast. Each tagging suggestion may be individually selectable, or tagging suggestions may be included in a tag group.

In some embodiments, UI 600 may be configured to retrieve current popular tags for the specific current location of the computing device, e.g., popular tags for the specific current location of the computing device from the most recent minute, hour, day, month, or year. Such embodiments may also be effective to consolidate asset tagging applied at a same “event”. For example, if the user is at a concert at the Pepsi Center in Denver, and “Location” tagging is selected, UI 600 may display the following tag groups:
Concert, KatyPerry, PepsiCenter, Pop
Concert, KatyPerry, PepsiCenter, Denver, Friends
Concert, KatyPerry, PepsiCenter, Denver, TruthTour
Concert, KatyPerry, PepsiCenter, Denver, Pop Friends, TruthTour, Music

After selection of location based tagging suggestions, UI 600 may place tagging suggestions from the selected tag group into auto-tagging field 205, where the user can modify the tagging suggestions and save the digital asset with the tags assigned via the UI 600.

FIG. 7 illustrates an example “Situational” digital asset tagging UI, according to some embodiments of this disclosure. “Situational” digital asset tagging UI 600 may comprise selectable tagging suggestions according to “Situational” digital asset tagging methods disclosed herein, optionally in combination with elements 201-207 introduced in FIG. 2.

In example “Situational” digital asset tagging methods, the computing device may detect one or more situational phenomena to include within tagging suggestions for the digital asset. For example, the computing device may detect any number of situational phenomena using sensors or other detection equipment, or a situation may be specified by the user via a field such as 701. The detected or specified situation may be included in tagging suggestions such as 711 or otherwise used to generate tagging suggestions 711. Tagging suggestions 711 may be presented individually or as a group. After selection of tagging suggestions 711, UI 700 may be configured to place the tagging suggestions 711 into auto-tagging field 205, where the user can modify the tagging suggestions before saving the digital asset with the tags assigned via the UI 700.

In an example “Situational” digital asset tagging scenario, if a user is riding a mountain bike, as may be detected for example from a chip or other type of passive transmitter on the bike or from processing accelerometer data, and the device has or is coupled with a GPS or other location service, an altimeter, and a heart rate monitor, and “situation” tagging is selected, UI 700 may show the following tagging suggestions:
Mountain Biking, Deer Creek Canyon, Elev 11,225 ft, HR 154

The computing device may be adapted to user a number of data sources to determine “situation” tagging suggestions. For example, the computing device may be adapted to sense the immediate proximity of the bicycle sensor, or to process accelerometer data to conclude the user is ‘biking’ or ‘mountain biking’ The device's GPS locates the user in the Deer Creek Canyon park trail system, and the device therefore adds ‘Deer Creek Canyon’ to the tagging suggestions 711. The device may be adapted to collect heart rate monitor data, and the device may therefore add ‘HR 154’ to the tagging suggestions 711. The device may be adapted to collect elevation data from the altimeter, and the device may therefore add ‘Elev 11,225 ft’ to the tagging suggestions 711.

A wide variety of sensors and data processing techniques may be employed to determine situational phenomena for situational tagging suggestions. Situational phenomena may include, for example: sensor readings from sensors such as accelerometers or heart rate monitors within or communicatively coupled with the computing device; situational phenomena derived from detection of a proximal computing device in proximity to the computing device, for example, if a nearby device that is associated with a known device user is detected, the name of the device user may be included in tagging suggestions; situational phenomena derived from detection of a proximal chip in proximity to the computing device, such as the chip on the bike described above, or a chip at any location; a date or a time from a device date and time service; ambient weather conditions as may be sensed locally or retrieved from a network weather service; and/or vehicle computer information.

In another example “Situational” digital asset tagging scenario, a computing device may comprise, or may be coupled with, a vehicle monitoring device adapted to take video footage and capture other vehicular related data of a moving vehicle. A video capture may be triggered by the deployment of a vehicle air bag or for example by exceeding a (de)acceleration threshold of an accelerometer, indicating a possible impact or collision. The device may be adapted to apply situation tagging suggestions to the captured video footage: date and time; GPS location; air bag(s) that deployed; names of people based the proximal detected devices passive transmitters; vehicular historical data that the vehicle monitoring device or vehicle was collecting prior to video capture, such as velocity, (de)acceleration, direction, etc.; weather data acquired (e.g., temperature, precipitation, cloud cover, etc.); traffic light condition and duration in that condition (e.g., picked up from traffic equipment that may broadcast information for other devices to collect).

The user or the computing device, if automatic tagging conditions are set, could select situational tagging suggestions 711, either individually or as a group of situational tags as shown in FIG. 7. After selection of situational based tagging suggestions, UI 700 may place selected tagging suggestions into auto-tagging field 205, where the user can modify the tagging suggestions and save the digital asset with the tags assigned via the UI 700.

FIG. 8 illustrates an example “Location Based Batch” digital asset tagging UI 800, according to some embodiments of this disclosure. “Location Based Batch” digital asset tagging UI 800 may comprise selectable common tag groups such as 811, 812, and/or 813 according to “Location Based Batch” digital asset tagging methods disclosed herein, optionally in combination with elements 201-207 introduced in FIG. 2.

In example “Location Based Batch” digital asset tagging methods, one or more selectable common tag groups, such as 811, 812, and/or 813 corresponding to one or more user-entered tags, e.g., tags entered in field 801, and a location of the computing device or digital asset, e.g., as determined from GPS or user entered location data, may displayed. Each selectable common tag group 811, 812, and/or 813 may comprise tagging suggestions from tag groups applied to multiple tagged digital assets at the location of the computing device or digital asset.

In some embodiments, with “Location Based Batch” tagging, as the user or the computing device starts to tag an asset, e.g., by entering a tag into field 801 or in some embodiments, by entering a tag into field 205 or 203 when location based batch is selected, the UI 800 may find popular batches matching the data entered in field 801, and also matching the current location of the computing device. UI 800 may display matching popular batches as selectable tag groups such as 811, 812, and/or 813. After selection of a tag group 811, 812, or 813, UI 800 may be configured to place the tagging suggestions from the selected group into auto-tagging field 205, where the user can modify the tagging suggestions before saving the digital asset with the tags assigned via the UI 800.

In an example “Location Based Batch” digital asset tagging scenario, a user may be at Cherry Creek Reservoir and may type the tag “Swim” into field 801. The UI 800 may display the following selectable tag groups, based on popular tags at that location that also include the tag “Swim”:
Swim, ¼ Mile, Sprint Triathlon
Swim, ½ Mile, OpenWater, Wetsuit
Swim, 1 Mile, Olympic Triathlon
Swim, 1 Mile, Exercise
Swim, Boating, Summer, Waterskiing

The user or the computing device, if automatic tagging conditions are set, could select a common tag group from among the selectable tag groups. After selection of a common tag group, UI 800 may place tagging suggestions from the selected common tag group into auto-tagging field 205, where the user can modify the tagging suggestions and save the digital asset with the tags assigned via the UI 800.

FIG. 9 illustrates an example “Situational Batch” digital asset tagging UI 900, according to some embodiments of this disclosure. “Situational Batch” digital asset tagging UI 900 may comprise selectable common tag groups 911 and/or 912 according to “Situational Batch” digital asset tagging methods disclosed herein, optionally in combination with elements 201-207 introduced in FIG. 2.

In example “Situational Batch” digital asset tagging methods, one or more selectable common tag groups such as 911 and/or 912 may be displayed. The displayed selectable common tag groups 911 and/or 912 may correspond to detected situational phenomena. The displayed selectable common tag groups 911 and/or 912 may optionally also correspond to one or more user-entered tags, e.g., such as entered in field 901. Each selectable common tag group 911 and/or 912 may comprise tagging suggestions from tag groups applied to multiple tagged digital assets exhibiting the detected situational phenomena.

In some embodiments, “Situational Batch” digital asset tagging UI 900 may be adapted to retrieve and display similar popular situation batched tags, e.g., in 911 and/or 912, the situation batched tags matching situations that the user and/or computing device is currently in, and also optionally matching tags entered in a field such as 901 as the user or computing device enters tags in field 901.

Using the mountain biking example above, a popular manual add to other tagging done at trails may be to add the names of the trails that were traveled. UI 900 may for example display the following selectable common tag groups based on popular tags for a detected ‘biking’ situation at a detected location:
Mountain Biking, Deer Creek Canyon, Cedar Trail
Mountain biking, Deer Creek Canyon, Cedar Trail, Look Out Trail

The user or the computing device, if automatic tagging conditions are set, could select a common tag group from among the selectable tag groups. After selection of a common tag group, UI 900 may place tagging suggestions from the selected common tag group into auto-tagging field 205, where the user can modify the tagging suggestions and save the digital asset with the tags assigned via the UI 900.

In another example scenario, using the Katy Perry concert example above, a user attending the concert may pass a chip and at the time they enter the venue, wherein the chip may transfer event details to passing computing devices, the event details including, e.g., GPS, event name, event schedule, venue name, event time, artists, time of performances, genre, etc. Alternatively, event details could be broadcast across the venue real time, to be used by computing devices for tagging. Captured event details may be used as situational tagging suggestions by the computing device, e.g., in response to the user taking a video or photo at the location of the venue and during the time window of the event.

Situational batch tagging may include, along with captured event details, popular tags that are also applied by the community of users attending the event. For example, UI 900 may retrieve and display the following selectable common tag group:
Concert, Music, KatyPerry, TruthTour, The One that Got Away,
PepsiCenter, Section 124, 9:42 PM, Pop, Rob, Diane, Peter, Mary

The user or the computing device, if automatic tagging conditions are set, could select the common tag group, and UI 900 may place the included tagging suggestions from the selected common tag group into auto-tagging field 205, where the user can modify the tagging suggestions and save the digital asset with the tags assigned via the UI 900.

FIG. 10 illustrates an example “Recognition” digital asset tagging UI 1000, according to some embodiments of this disclosure. “Recognition” digital asset tagging UI 1000 may comprise selectable tagging suggestions 1001 according to “Recognition” digital asset tagging methods disclosed herein, optionally in combination with elements 201-207 introduced in FIG. 2.

In example “Recognition” digital asset tagging methods, one or more objects represented within the digital asset may be identified and included within tagging suggestions 1001 for the digital asset. Recognition based tagging may allow the user or device to find recognized objects within the asset (photo, video, audio, etc.) that was captured or added. This allows the user or computing device to easily select descriptive recognition tags based on what was recognized in the asset (i.e., a building, a bicycle, a person, a car, an SUV, and/or other objects).

In an example “Recognition” digital asset tagging scenario, a user may take a video of a performing band, e.g., Jack White of the White Strips. In response to selecting recognition based tagging, the computing device may initiate image recognition processes on the captured video, and UI 1000 may display, e.g., the following tagging suggestions:
Band, Drums, Electric Guitar, Jack White, White Stripes, Concert, Music

The user or the computing device, if automatic tagging conditions are set, could select one or more of the tagging suggestions, or all tagging suggestions if presented within a tag group, and UI 1000 may place the selected tagging suggestions into auto-tagging field 205, where the user can modify the tagging suggestions and save the digital asset with the tags assigned via the UI 1000.

FIG. 11 illustrates an example “Social Network Data” digital asset tagging UI 1100, according to some embodiments of this disclosure. “Social Network Data” digital asset tagging UI 1100 may comprise selectable tagging suggestions 1101 according to “Social Network Data” digital asset tagging methods disclosed herein, optionally in combination with elements 201-207 introduced in FIG. 2.

In example “Social Network Data” digital asset tagging methods, social network data associated with the digital asset may be included within tagging suggestions such as 1101 for the digital asset. For example, if the digital asset is shared with social network connections, identifications such as usernames of those with whom the digital asset was shared may be included among the tagging suggestions 1101. If the digital asset was downloaded from a social media website such as FACEBOOK®, a username of the author or person originally sharing the digital asset may be included among the tagging suggestions 1101. A wide variety of social network data may be gathered and used as tagging suggestions 1101 for the digital asset, and this disclosure extends to the application of any social network data as tagging suggestions.

The user or the computing device, if automatic tagging conditions are set, may select one or more of the tagging suggestions from UI 1100, or all tagging suggestions if presented within a tag group, and UI 1100 may place the selected tagging suggestions into auto-tagging field 205, where the user can modify the tagging suggestions and save the digital asset with the tags assigned via the UI 1100.

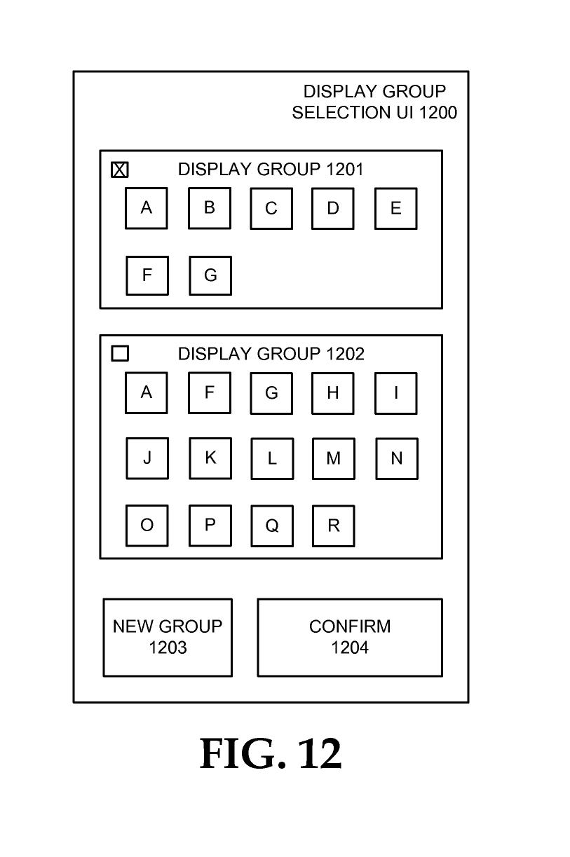

FIG. 12 illustrates an example display group selection UI 1200, according to some embodiments of this disclosure. Display group selection UI 1200 includes selectable display groups 1201 and 1202, a new group control 1203, and a confirm control 1204. Display group 1201 includes tagged digital assets A, B, C, D, E, F, and G. Display group 1202 includes tagged digital assets A, F, G, H, I, J, K, L, M, N, O, P, Q, and R.

In some embodiments, the computing device may be adapted to display a display group selection UI 1200 after tags are applied to a digital asset, e.g., after tags are applied via any of UI 200-1100. For example, UI 1200 may be displayed in response to selection of the confirm tags control 207 in any of UI 200-1100. UI 1200 may be adapted to display all display groups previously created by the user and/or created by other users and shared with the user, as well as optionally a new group control 1203 to initiate creation of new display groups. In the illustrated UI 1200, the user has created two display groups 1201 and 1202, and has previously assigned certain digital assets to each.

UI 1200 may be adapted to receive display group selections for a current digital asset under management. For example, the “X” in the selection box at top left of display group 1201 indicates the user has selected display group 1201. UI 1200 may be adapted to include the digital asset among other digital assets in the selected display group 1201, e.g., in response to user selection of the confirm control 1204. In some embodiments, UI 1200 may be adapted to allow selecting multiple display groups, in which case the digital asset may be placed into each selected display group. For example, the digital asset may be placed into both 1201 and 1202.

In some embodiments, display groups may be shared across multiple users. Users may access display groups for example by synchronizing display groups from their respective computing devices, or logging onto a website comprising the display groups.

FIG. 13 illustrates an example automatic tagging configuration UI 1300, according to some embodiments of this disclosure. Automatic tagging configuration UI 1300 includes controls 1301 and 1302 adapted to activate and deactivate automatic tagging, selectable automatic tagging configuration settings 1303, and a control 1304 for confirming automatic tagging configuration settings.

In some embodiments, an automatic tagging configuration UI 1300 may be displayed for example in response to user navigation to the UI 1300 to configure automatic digital asset tagging by the computing device. UI 1300 may be adapted to receive an automatic tagging activation or deactivation, e.g., via controls 1301 and 1302. Some embodiments may omit global activation and deactivation functions and need not include 1301 and 1302. UI 1300 may be adapted to receive one or more automatic tagging configuration settings, e.g., via selectable boxes or other controls included in the automatic tagging configuration settings 1303. The one or more automatic tagging configuration settings 1303 may comprise, e.g., at least one of: a date tag setting, a time tag setting, a location tag setting, a names of recognized persons tag setting; a last tag setting; and/or a social network data tag setting. Additional settings, including settings for automatically applying and configuring any of the various tagging methods disclosed herein, may be included in UI 1300 as will be appreciated with the benefit of this disclosure. For example, the “Last” configuration setting may cause the computing device to automatically apply the tags from the immediate previously tagged asset to a next digital asset to be tagged as discussed herein. A “location” configuration setting may include further controls for selecting how to configure location tags, e.g., as city and state, or as closest landmark, or as closest street address, etc.

After settings are confirmed, e.g., via confirm settings control 1304, the computing device may be adapted to automatically associate one or more tags with digital assets according to one or more activated automatic tagging configuration settings 1303 when automatic tagging is activated via the automatic tagging configuration UI 1300.

FIG. 14 illustrates selectable auto-complete suggestions 1401 displayed for characters entered into a type tagging field such as 203, according to some embodiments of this disclosure. FIG. 14 also includes the tagging selection UI 200 and elements 201-207 thereof, as described in connection with FIG. 2.

The type tagging field 203 may be adapted for assisted manual entry of tags for the digital asset as illustrated in FIG. 14. The computing device may be adapted to display selectable auto-complete suggestions 1401 for characters entered into the type tagging field 203 for assisted manual entry of tags. The selectable auto-complete suggestions may include suggestions from a database of previously applied tags. For example, in FIG. 14, the user has typed an “M” into type-tagging field 203. The computing device has displayed selectable auto-complete suggestions from a database of previously applied tags, including: Macie, Merin, Mexico, Music, Mountain Biking, Monster, Marathon, Mom.

In some embodiments, the computing device may be adapted to retrieve selectable auto-complete suggestions 1401 from a local database within the computing device, the local database comprising tags applied by the user of the computing device. In some embodiments, the computing device may be adapted to retrieve selectable auto-complete suggestions 1401 from a community database comprising tags applied by a community of computing device users. In some embodiments, a combination of local and community databases may be used. Tags applied by the community of computing device users may comprise tags applied more than a threshold number of times by the community of computing device users, e.g., more than 5000 times, or any other threshold number. In some embodiments, the computing device may be adapted to visually differentiate between personal tags and community tags, e.g., by displaying the tags in different subgroups, different colors, or other means of visual differentiation.

The user or the computing device, if automatic tagging conditions are set, may select one or more of the auto-complete suggestions from UI 1400, and UI 1400 may place the selected suggestions into type tagging field 203, where the user can modify the tagging suggestions and save the digital asset with the tags assigned via the UI 1400.

FIG. 15 illustrates an example computing device configured with a tagging application to implement the various UI and methods according to this disclosure. In a very basic configuration 1501, computing device 1500 may include one or more processors 1510 and a system memory 1520. A memory bus 1530 may be used for communicating between processor 1510 and system memory 1520.

Depending on the desired configuration, processor 1510 may be of any type including but not limited to a microprocessor (μP), a microcontroller (μC), a digital signal processor (DSP), or any combination thereof. Processor 1510 may include one or more levels of caching, such as a level one cache 1511 and a level two cache 1512, a processor core 1513, and registers 1514. Processor core 1513 may include an arithmetic logic unit (ALU), a floating point unit (FPU), a digital signal processing core (DSP Core), or any combination thereof. A memory controller 1515 may also be used with processor 1510, or in some implementations memory controller 1515 may be an internal part of processor 1510.

Depending on the desired configuration, system memory 1520 may be of any type including but not limited to volatile memory (such as RAM), non-volatile memory (such as ROM, flash memory, etc.), or any combination thereof. System memory 1520 typically includes an operating system 1521, one or more applications 1522, and program data 1525. In some embodiments, operating system 1521 may comprise a virtual machine that is managed by a Virtual Machine Manager (VMM). Applications 1522 may include a tagging application 1523, also referred to herein as a “digital fridge” application, which may provide the various UI illustrated herein. Program data 1525 may include tagging data 1526 and any other data that may be used by client tagging application 1523, such as a tagging suggestions database as described herein. Computing device 1500 may also connect with other computing devices 1590 to access cloud or remote data base storage comprising a tagging suggestions database, e.g., to access community tagging data as well as update community tagging data.

Computing device 1500 may have additional features or functionality, and additional interfaces to facilitate communications between the basic configuration 1501 and any required devices and interfaces. For example, a bus/interface controller 1540 may be used to facilitate communications between the basic configuration 1501 and one or more data storage devices 1550 via a storage interface bus 1541. The data storage devices 1550 may be removable storage devices 1551, non-removable storage devices 1552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

Level 1 cache 1511, level 2 cache 1512, system memory 1520, removable storage 1551, and non-removable storage devices 1552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 1500. Any such computer storage media may be part of device 1500.

Computing device 1500 may also include an interface bus 1542 for facilitating communication from various interface devices (e.g., output interfaces, peripheral interfaces, and communication interfaces) to the basic configuration 1501 via the bus/interface controller 1540. Example output devices 1560 include a graphics processing unit 1561 and an audio processing unit 1562, which may be configured to communicate to various external devices such as a display or speakers via one or more A/V ports 1563. Example peripheral interfaces 1570 may include a serial interface controller 1571 or a parallel interface controller 1572, which may be configured to communicate through either wired or wireless connections with external devices such as input devices (e.g., keyboard, mouse, pen, voice input device, touch input device, etc.) or other peripheral devices (e.g., printer, scanner, etc.) via one or more I/O ports 1573. Other conventional I/O devices may be connected as well such as a mouse, keyboard, and so forth. An example communications device 1580 includes a network controller 1581, which may be arranged to facilitate communications with one or more other computing devices 1590 via one or more communication ports 1582.

In some embodiments, computing device 1500 may be implemented as mobile device such as a smart phone or tablet computing device. Computing device 1500 may also be implemented a business or personal use computer including both laptop computer and non-laptop computer configurations. Computing device 1500 may also be implemented as virtually any other device including for example a digital camera, a television set, a DVD player, an eBook reader, and/or a gaming console.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art.

1. A method for tagging a digital asset by a computing device, comprising:
displaying, by the computing device, a tagging selection UI adapted to receive a tagging method selection from among a plurality of selectable tagging methods for applying tags to the digital asset, the plurality of selectable tagging methods comprising one or more of:
a “last” tagging method, wherein tags applied to an immediate previous tagged digital asset are included within tagging suggestions for the digital asset;
a “recent” tagging method, wherein one or more selectable recent tag groups are displayed, each selectable recent tag group comprising tagging suggestions from tag groups applied to one or more previous tagged digital assets;
a “batch” tagging method, wherein one or more selectable common tag groups corresponding to one or more user-entered tags are displayed, each selectable common tag group comprising tagging suggestions from tag groups applied to multiple tagged digital assets;
a “location” tagging method, wherein tags applied to digital assets at a location of the computing device are included within tagging suggestions for the digital asset;
a “situational” tagging method, wherein the computing device detects one or more situational phenomena to include within tagging suggestions for the digital asset;
a “location-based batch” tagging method, wherein one or more selectable common tag groups corresponding to one or more user-entered tags and a location of the computing device are displayed, each selectable common tag group comprising tagging suggestions from tag groups applied to multiple tagged digital assets at the location of the computing device; and
a “situational batch” tagging method wherein one or more selectable common tag groups corresponding detected situational phenomena are displayed, each selectable common tag group comprising tagging suggestions from tag groups applied to multiple tagged digital assets exhibiting the detected situational phenomena;
receiving, by the computing device, a tagging method selection from among the plurality of selectable tagging methods;
displaying, by the computing device, a digital asset tagging UI corresponding to the received tagging method selection, the digital asset tagging UI comprising a plurality of tagging suggestions;
receiving, by the computing device, a user confirmation of one or more tags from among the tagging suggestions displayed in the digital asset tagging UI;
associating, by the computing device, the one or more tags with the digital asset; and
storing, by the computing device, the one or more tags associated with the digital asset.

2. The method of claim 1, wherein the plurality of selectable tagging methods further comprises a “recognition” tagging method, wherein one or more objects represented within the digital asset are identified and included within tagging suggestions for the digital asset.

3. The method of claim 1, wherein the plurality of selectable tagging methods further comprises a “social network data” tagging method, wherein social network data associated with the digital asset is included within tagging suggestions for the digital asset.

4. The method of claim 1, wherein digital asset tagging UI comprises a field for manual adding, editing, and deleting tags from the tagging suggestions.

5. The method of claim 1, further comprising displaying, by the computing device, a type tagging field for assisted manual entry of tags for the digital asset, wherein the computing device is adapted to display selectable auto-complete suggestions for characters entered into the type tagging field for assisted manual entry of tags, and wherein the selectable auto-complete suggestions include suggestions from a database of previously applied tags.

6. The method of claim 5, wherein the database of previously applied tags includes tags applied by a community of computing device users.

7. The method of claim 6, wherein the tags applied by the community of computing device users are tags applied more than a threshold number of times by the community of computing device users.

8. The method of claim 1, further comprising:
displaying, by the computing device, a display group selection UI adapted to:
display one or more selectable display groups; and
receive a display group selection; and
including, by the computing device, the digital asset among other digital assets in the selected display group.

9. The method of claim 1, wherein the plurality of selectable tagging methods comprises the “location” tagging method, and wherein the “location” tagging method is adapted to include, within tagging suggestions for the digital asset, tags applied to digital assets by a community of computing device users at the location of the computing device.

10. The method of claim 1, wherein the plurality of selectable tagging methods comprises the “batch” tagging method, the “location-based batch” tagging method, and/or the “situational batch” tagging method, and wherein the “batch” tagging method, the “location-based batch” tagging method, and/or the “situational batch” tagging method is a is adapted to include, within the one or more selectable common tag groups, tag groups applied to digital assets by a community of computing device users.

11. The method of claim 1, wherein the plurality of selectable tagging methods comprises the “situational” tagging method, wherein the “situational” tagging method is adapted to include, within the one or more situational phenomena, one or more of:
a sensor reading from a sensor within or communicatively coupled with the computing device;
a situational phenomena derived from detection of a proximal computing device in proximity to the computing device;
a situational phenomena derived from detection of a proximal chip in proximity to the computing device;
a date;
a time;
ambient weather conditions; and/or
vehicle computer information.

12. The method of claim 1, further comprising:
displaying, by the computing device, an automatic tagging configuration UI adapted to receive an automatic tagging activation or deactivation and one or more automatic tagging configuration settings, the one or more automatic tagging configuration settings comprising at least one of: a date tag setting, a time tag setting, a location tag setting, and a names of recognized persons tag setting;
automatically associating, by the computing device, one or more tags with digital assets according to one or more activated automatic tagging configuration settings when automatic tagging is activated via the automatic tagging configuration UI.

13. A non-transitory computer readable storage medium having computer executable instructions executable by a processor, the instructions that, when executed by the processor, implement a digital asset tagging tool, which causes the processor to:
display a tagging selection UI adapted to receive a tagging method selection from among a plurality of selectable tagging methods for applying tags to the digital asset, the plurality of selectable tagging methods comprising one or more of:
a “last” tagging method, wherein tags applied to an immediate previous tagged digital asset are included within tagging suggestions for the digital asset;
a “recent” tagging method, wherein one or more selectable recent tag groups are displayed, each selectable recent tag group comprising tagging suggestions from tag groups applied to one or more previous tagged digital assets;
a “batch” tagging method, wherein one or more selectable common tag groups corresponding to one or more user-entered tags are displayed, each selectable common tag group comprising tagging suggestions from tag groups applied to multiple tagged digital assets;
a “location” tagging method, wherein tags applied to digital assets at a location of the computing device are included within tagging suggestions for the digital asset;
a “situational” tagging method, wherein the computing device detects one or more situational phenomena to include within tagging suggestions for the digital asset;
a “location-based batch” tagging method, wherein one or more selectable common tag groups corresponding to one or more user-entered tags and a location of the computing device are displayed, each selectable common tag group comprising tagging suggestions from tag groups applied to multiple tagged digital assets at the location of the computing device; and
a “situational batch” tagging method wherein one or more selectable common tag groups corresponding to detected situational phenomena are displayed, each selectable common tag group comprising tagging suggestions from tag groups applied to multiple tagged digital assets exhibiting the detected situational phenomena;
display a digital asset tagging UI corresponding to a tagging method selection, the digital asset tagging UI comprising a plurality of tagging suggestions;
associate one or more tags from among the tagging suggestions displayed in the digital asset tagging UI with the digital asset; and
store the one or more tags associated with the digital asset.

14. A computing system configured to provide a digital asset tagging tool, comprising:
a processor;
a memory; and
a digital asset tagging tool stored in the memory and executable by the processor, wherein the digital asset tagging tool is configured to:
display a tagging selection UI adapted to receive a tagging method selection from among a plurality of selectable tagging methods for applying tags to the digital asset, the plurality of selectable tagging methods comprising one or more of:
a “last” tagging method, wherein tags applied to an immediate previous tagged digital asset are included within tagging suggestions for the digital asset;
a “recent” tagging method, wherein one or more selectable recent tag groups are displayed, each selectable recent tag group comprising tagging suggestions from tag groups applied to one or more previous tagged digital assets;
a “batch” tagging method, wherein one or more selectable common tag groups corresponding to one or more user-entered tags are displayed, each selectable common tag group comprising tagging suggestions from tag groups applied to multiple tagged digital assets;
a “location” tagging method, wherein tags applied to digital assets at a location of the computing device are included within tagging suggestions for the digital asset;
a “situational” tagging method, wherein the computing device detects one or more situational phenomena to include within tagging suggestions for the digital asset;
a “location-based batch” tagging method, wherein one or more selectable common tag groups corresponding to one or more user-entered tags and a location of the computing device are displayed, each selectable common tag group comprising tagging suggestions from tag groups applied to multiple tagged digital assets at the location of the computing device; and
a “situational batch” tagging method wherein one or more selectable common tag groups corresponding to detected situational phenomena are displayed, each selectable common tag group comprising tagging suggestions from tag groups applied to multiple tagged digital assets exhibiting the detected situational phenomena;
display a digital asset tagging UI corresponding to a tagging method selection, the digital asset tagging UI comprising a plurality of tagging suggestions;
associate one or more tags from among the tagging suggestions displayed in the digital asset tagging UI with the digital asset; and
store the one or more tags associated with the digital asset.
